(19) United States
(12) Patent Application Publication
(10) Pub. No.: US 2006/0262929 A1
(43) Pub. Date: Nov. 23, 2006

(54) Method and system for identifying the identity of a user

(75) Inventors: Harri Vatanen, Sunningdale (GB); Pekka Jelekainen, Helsinki (FI)

Correspondence Address: MERCHANT & GOULD PC, P.O. BOX 2903, MINNEAPOLIS, MN, 55402-0903, US

(73) Assignee: QITEC TECHNOLOGY GROUP OY, HELSINKI (FI)

(21) Appl. No.: 10/544,119

(22) PCT Filed: Jan. 29, 2004
(86) PCT No.: PCT/FI04/00043

§ 371 Date: Aug. 3, 2006

(30) Foreign Application Priority Data
Jan. 31, 2003 (FI) 20030154

(51) Int. Cl. H04K 1/00

(52) U.S. Cl. 380/255

(57) ABSTRACT

The present invention describes a method and system for verifying the identity of a user of a first terminal in a communication system having at least a communication network (NET), a first terminal (DTE) associated with the communication network (NET) and a service provider (SP) associated with the communication network (NET). In the method, a first logical channel is set up via the communication network between the first terminal (DTE) and the service provider (SP). The user of the first terminal is identified after the first logical channel set up via a second logical channel other than the established first logical channel between the service provider and the first terminal prior to providing any services to the caller.

### FIELD OF THE INVENTION

The present invention relates to communication systems. In particular, the present invention relates to a novel and improved method and system for identifying a user in a communication system.

### BACKGROUND OF THE INVENTION

User identification is an essential procedure for various tasks in the Internet environment. User identification is needed in various environments, e.g. in email login, on-line shopping, on-line banking etc. There is always a fundamental problem to be solved when using on-line identification methods, namely, how to make sure that the person making the identification is actually the person who he/she claims to be.

For identification purposes, several solutions are used to solve the aforementioned problem. A basic solution is to use a username and password. The username/password combination is often adequate for identification purposes but not always. Today, a number of services require user identification, and for this reason, an individual may have tens of different username/password pairs stored somewhere, e.g. in a computer or a paper sheet in a drawer. Therefore, sometimes these username/password pairs may end up to people not authorized to use them, e.g. the computer may be vulnerable for hacking or the drawer is too obvious place to hide the username/password pairs.

There are also other identification solutions used in on-line identification solutions. A user may use one or more static piece of identification information (e.g. username and/or password) but also a varying piece of information (e.g. a varying PIN code) is needed. This is the solution at least in several on-line banking solutions. In these solutions, each session and/or transaction requires a predetermined varying identifier to be used.

The current discussion about identification solutions primarily concentrates on Internet-based solutions. This is of course important because data networks, such as the Internet, are always vulnerably to hostile attacks or hackers.

There are, however, also a number of on-line identification solutions used in telephone networks. There exists several phone services through which confidential information can be acquired or changed, e.g. telephone bank services, various health-related services, telephone operator services etc. In such services, some kind of identification procedure is often used. A calling person can be identified e.g. based on the A-number (calling line identification), customer identification number, PIN code, username and/or password etc. These solutions are very similar to the ones used in Internet-based solutions.

All the aforementioned solutions have, however, some drawbacks. Some of these drawbacks will now be discussed shortly:

A-number (calling line identification): An A-number identifies only the terminal or subscription from which the phone call is set up. It does not necessarily identify the calling person. It is always possible that someone fraudulently poses as being someone else.

Personal Identification Number (PIN): A PIN code can be used alone or with e.g. the A-number in identification. It may be difficult, as previously mentioned, to remember PIN codes related to each service. Again it is possible that someone fraudulently poses as being someone else.

Varying PIN code with a customer identification number: This solution was discussed above briefly. Systems based on using varying PIN code with a customer identification number are in itself reliable but expensive to set up, use and maintain. Solution of this kind is used at least by telephone banks or other service providers using an up-to-date regular customer system.

Some of the services provided by the public sector or other (private or commercial) service providers have a need to implement a significant part of the existing services via telephone voice connections. These services, however, require a reliable identification of an individual or customer before providing the service. Furthermore, some of the services provided by the public sector or other (private or commercial) service providers via telephone voice connections require a digital signature from the individual or customer.

Therefore, there is particularly an obvious need for a reliable on-line telephone identification solution with which a calling person can be identified prior to providing service via the telephone connection. The solution should be secure and above all, easy to use and adopt and widely available when needed.

### SUMMARY OF THE INVENTION

The present invention describes a method and system for identifying the identity of a user of a first terminal in a communication system. The system comprises at least a communication network, a first terminal associated with the communication network, a service provider associated with the communication network and a certificate service provider. Furthermore, the first terminal preferably refers to a mobile phone.

In the method, a first logical channel is set up from the first terminal to the service provider.

The service provider refers e.g. to a bank, police, post office, operator, credit card company, insurance company, telephone bank; social insurance institution etc. The identity of the user of the first terminal is then identified via a second logical channel other than the established first logical channel between the service provider and the first terminal prior to providing any services to the user of the first terminal via the established first logical channel. In other words, the present invention uses a second logical channel to identify the identity of the user of a first terminal. The logical channels may be circuit switched or packet switched. Furthermore, the user may be identified by a separate party via the second logical channel, the party being other than the user of the first terminal.

In one embodiment, the communication network is a mobile telephone network. In one embodiment, the first and/or second logical channel refers to the standardized GSM network data transmission feature that can be used simultaneously during a circuit switched speech connection. In other embodiments, the logical channels may refer e.g. to transmission channels of a GPRS, UMTS, WCDMA, CDMA, EDGE, Bluetooth, WLAN network or to any other existing or future data transmission network.

In one embodiment of the present invention, the service provider sends a user identification request to the first terminal via a second logical channel (e.g. via a packet switched connection) while a first logical channel exists between the first terminal and the service provider. The request is preferably sent to the first terminal directly and more preferably, using a security gateway forming an interface towards the first terminal. The request is preferably encrypted. The first terminal receives the request and decrypts it if encryption was used. In order to give an adequate indication of the identity of the user of the first terminal, the request is signed digitally by the first terminal.

In order to create a digital signature, the first and/or second terminals need to comprise an encryption key, and furthermore in order to create the digital signature, the user of a terminal must have a correct pass phrase or PIN code to activate the signature creation. The signed identification request is then sent either directly to the service provider or more preferably, to the security gateway. The signed request may also be encrypted by the first and/or second terminal.

The digital signature is then verified based on a certificate corresponding to the authentication key used in creating the digital signature, the certificate being acquired from a certificate service provider or other service provider. The verification is preferably made by the service provider, and more preferably, by the security gateway. If the user is properly authenticated and the result of the verification is positive, the user of the first terminal may now be provided with services provided by the service provider via the existing first logical channel.

For some reason, the set up first logical channel may fail while the identification and validation process is still unfinished. Therefore, a procedure for re-establishing a validated connection has to be provided. If the first logical channel fails during the verification procedure, the service provider creates a challenge, e.g. a password, and encrypts it using the public encryption key of the user of the first terminal. The encrypted challenge is then sent to the first terminal either directly or more preferably, using the security gateway. The first terminal decrypts the encrypted challenge, sets up a new logical channel to the service provider and provides the service provider with the decrypted challenge. If the challenge is acceptable, the user of the first terminal is provided via the re-established logical channel with a service by the service provider.

The present invention enables a reliable identification of an individual or a customer over a logical channel, e.g. a telephone line. The present invention provides a solution wherein multiple services can use the same security solution for authentication, authorization, administration and access control. Furthermore, the solution is cost-efficient, secure and easy to implement into the existing systems.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a flow diagram illustrating a user identification procedure in accordance with the present invention,

FIG. 2 is a flow diagram illustrating a user identification procedure in accordance with the present invention,

FIG. 3 is a flow diagram illustrating a re-establishing procedure in accordance with the present invention,

FIG. 4 is a flow diagram illustrating a user identification procedure in accordance with the present invention,

FIG. 5 is a flow diagram illustrating a re-establishing procedure in accordance with the present invention,

FIG. 6 is a flow diagram illustrating a user identification procedure in accordance with the present invention,

FIG. 7 is a flow diagram illustrating a user identification procedure in accordance with the present invention,

FIG. 8 is a flow diagram illustrating a user identification procedure in accordance with the present invention, and

FIG. 9 is a block diagram of an embodiment of the system in accordance with the present invention.

### DETAILED DESCRIPTION OF THE INVENTION

Reference will now be made in detail to the embodiments of the present invention, examples of which are illustrated in the accompanying drawings.

In the following examples, a user is considered to be a user making a phone call. It is evident that the call connection may be any other appropriate logical channel or connection (e.g. a packet switched channel or connection) between a user terminal and a service provider.

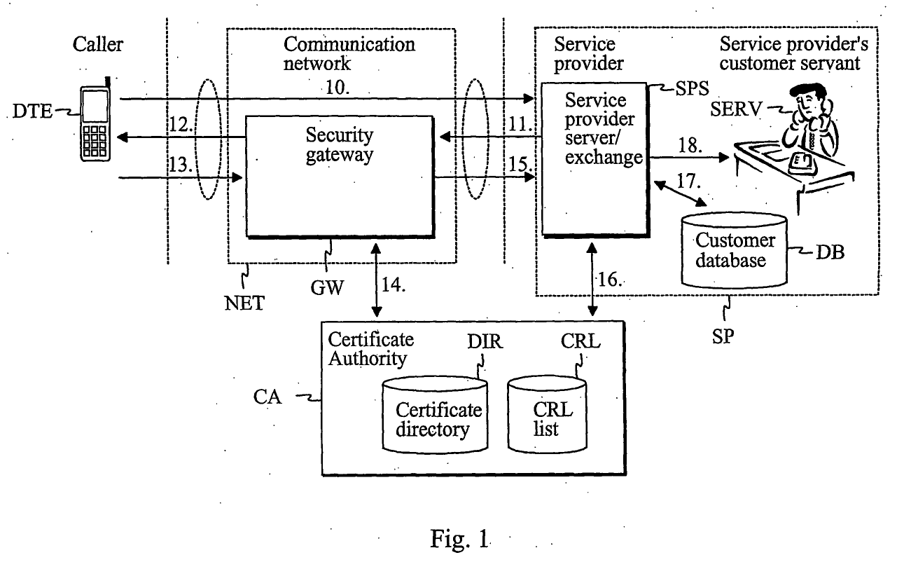

FIG. 1 describes an embodiment of a user identification procedure. A call connection is set up (10) from a caller terminal DTE to a service number of a service provider SP via a communication network NET. The service provider SP refers e.g. to a bank, police, post office, operator, credit card company, insurance company, telephone bank or social insurance institution. It may, however, be any other company or institution that provides services requiring undisputed identification of the caller. In FIG. 1, the service provider SP comprises at least a service provider server/exchange SPS, customer database DB and customer servant SERV. The communication network NET is preferably a mobile telephone network. The caller terminal DTE is preferably a mobile phone comprising a subscriber identity module SIM. Instead of a subscriber identity module SIM, a Wireless Identity Module (WIM), an UMTS Subscriber Identity Module (USIM), a security module or any other tamper-proof device can be used. The subscriber identity module SIM or any other tamper-proof device enables encryption and decryption of information and also forming of a digital signature. In a preferred embodiment, the subscriber identity module SIM or any pother tamper-proof device also comprises a storage for encryption and/or decryption keys. Furthermore, in a preferred embodiment, Public Key Infrastructure (PKI) is used in encryption and decryption.

The service provider server SPS sends a caller identification request (11) to a security gateway GW. In FIG. 1, the security gateway GW is owned by the operator of the communication network NET and it provides various security-related functions, such as encrypting and decrypting. The request (11) is transmitted to the security gateway GW through a secured connection (e.g. Secured Sockets Layer (SSL)) e.g. in the form of HyperText Transfer Protocol (HTTP), Wireless Markup Language (WML) or Extensible Markup Language (XML).

It is very important to note that, in this embodiment, the call connection is maintained during the identification phase.

The security gateway GW identifies the service provider SP based on a service provider certificate, decrypts the secured connection and receives the caller identification request in clear text e.g. in the form of XML, WML or short message. The caller identification request is then converted into a form understood by the subscriber identity module SIM of the mobile terminal DTE and encrypted with symmetric encryption method of the Global System for Mobile communications (GSM). The encrypted message is then sent (12) to the mobile phone DTE.

The mobile phone DTE and/or the subscriber identity module SIM decrypt(s) the message and the decrypted message is displayed to the caller on the display of the mobile phone DTE. The subscriber identity module SIM may comprise a browser that converts the message into SIM Toolkit commands prior to displaying the message on the display. The displayed message is then digitally signed with an authentication key of the caller, and the signed message is sent (13) to the security gateway GW. The signed message is preferably converted into the form Public-Key Cryptography Standards #1 (PKCS#1) and encrypted prior to sending. PKCS#1 is further described e.g. in http://www.rsasecurity.com/rsalabs/pkcs/.

The security gateway GW decrypts the message and fetches (14) a certificate related to the subscriber from a certificate directory DIR of a certificate authority CA. The certificate authority CA maintains one or more certificate directories and a certificate revocation list CLR comprising information about revoked certificates. A certificate comprises identification information of the certificate owner and above all, the public key of the owner. With the public key it is possible to verify a digital signature. Verification process refers to a process performed by a verifier either soon after the creation of an electronic signature or later to determine if an electronic signature is valid against a signature policy implicitly or explicitly referenced. Verification is linked very strongly to the term ‘validation data’. Validation data refers to the additional data needed to validate the electronic signature; this includes e.g. certificates, revocation status information (e.g. CRLs) and trusted time-stamps. Furthermore, the security gateway GW creates a PKCS#7 message and sends (15) the message to the service provider SP preferably using a secured connection. PKCS#7 is further described e.g. in http://www.rsasecurity.com/rsalabs/pkcs/.

The service provider SP authenticates the caller and verifies (16) the digital signature and checks from the certificate revocation list CLR that the certificate is valid. If the verification procedure was successful, the caller may now be provided the requested service. Furthermore, the service provider may create a data record containing the caller information (17) from the database DB, validation information and a call log information. Call log information simply indicates that the call had existed during the identification procedure. The customer servant SERV preferably uses a computer, and therefore, is automatically provided (18) with the aforementioned data record prior to talking to the caller.

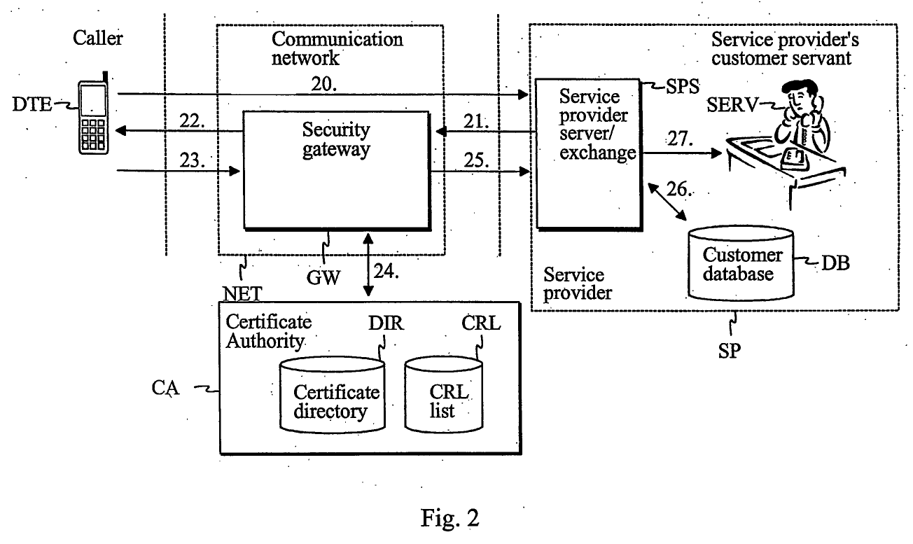

FIG. 2 describes another embodiment of a user identification procedure. A call is set up (20) from a caller terminal DTE to a service number of a service provider SP via a communication network NET. The service provider SP refers e.g. to any private, commercial or state-owned institution, e.g. to a bank, police, post office, operator, credit card company, insurance company, telephone bank or social insurance institution. It may, however, be any other company or institution that provides services requiring undisputed identification of the caller. In FIG. 2, the service provider SP comprises at least a service provider server/exchange SPS, customer database DB and customer servant SERV. The communication network NET is preferably a mobile telephone network. The caller terminal DTE is preferably a mobile phone comprising a subscriber identity module SIM. Instead of a subscriber identity module SIM, a Wireless Identity Module (WIM), an UMTS Subscriber Identity Module (USIM), a security module or any other tamper-proof device can be used. The subscriber identity module SIM or any other tamper-proof device enables encryption and decryption of information and also forming of a digital signature. In a preferred embodiment, the subscriber identity module SIM also comprises a storage for encryption and/or decryption keys. Furthermore, in a preferred embodiment, Public Key Infrastructure (PKI) is used in encryption and decryption.

The service provider SPS sends a caller identification request (21) to a security gateway GW. In FIG. 2, the security gateway GW is owned by the operator of the communication network NET and it provides various security-related functions, such as encrypting and decrypting. The request (21) is transmitted to the security gateway GW through a secured connection (e.g. Secured Sockets Layer (SSL)) e.g. in the form of HyperText Transfer Protocol (HTTP), Wireless Markup Language (WML) or Extensible Markup Language (XMLY.

It is very important to note that the call connection is maintained during the identification phase.

The security gateway GW identifies the service provider SP based on a service provider certificate, decrypts the secured connection and receives the caller identification request in clear text e.g. in the form of XML, WML or short message. The caller identification request is then converted into a form understood by the subscriber identity module SIM of the mobile terminal DTE and encrypted with symmetric encryption method of the Global System for Mobile communications (GSM). The encrypted message is then sent (22) to the mobile phone DTE.

The mobile phone DTE and/or the subscriber identity module SIM decrypt(s) the message and the decrypted message is displayed to the caller on the display of the mobile phone DTE. The subscriber identity module SIM may comprise a browser that converts the message into SIM Toolkit commands prior to displaying the message on the display. The displayed message is then digitally signed with an authentication key of the caller and the signed message is sent (23) to the security gateway GW. The signed message is preferably converted into the form Public-Key Cryptography Standards #1 (PKCS#1) and encrypted prior to sending. PKCS#1 is further described e.g. in http://www.rsasecurity.com/rsalabs/pkcs/.

The security gateway GW decrypts the message and fetches (24) a certificate related to the subscriber from a certificate directory DIR of a certificate authority CA. The certificate authority CA maintains one or more certificate directories and a certificate revocation list CLR comprising information about revoked certificates. The certificate authority CA may also comprise information about which users are authorized for one or more services and which are not. A certificate comprises identification information of the certificate owner and above all, the public key of the owner. With the public key it is possible to verify a digital signature. The security gateway GW verifies the digital signature and checks from the certificate revocation list CLR that the certificate is valid. If the verification procedure was successful, the security gateway GW sends (25) verification positive message to the service provider SP preferably using a secured connection. The service provider server then creates a data record containing the caller information (26) from a database DB, validation information and a call log information. Call log information simply indicates that the call had existed during the identification procedure. The customer servant SERV preferably uses a computer, and therefore, is automatically provided (27) with the aforementioned data record prior to talking to the caller.

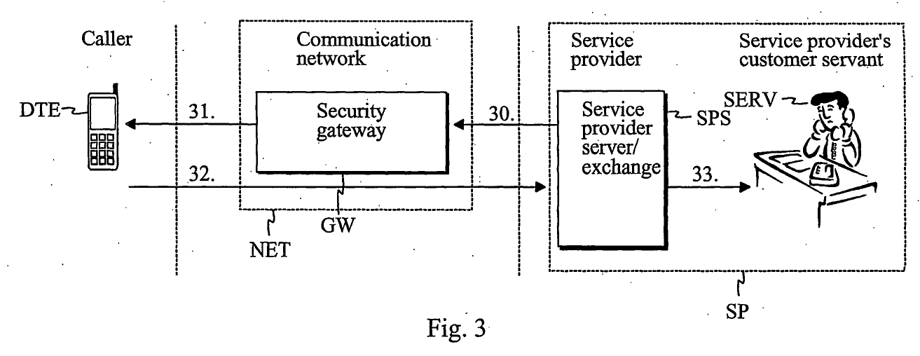

FIG. 3 describes an embodiment in which the originally establish call connection fails and the call connection is re-established.

When the service provider server SPS detects that the call connection does not exist any more, it creates a challenge. A challenge is any piece of information containing e.g. alphanumeric characters. The challenge is then encrypted using the public key of the caller. The public key is acquired from a previous PKCS#7 message, or if such message has not been received, from a public certificate directory. After this, the service provider server SPS sends (30) the encrypted challenge via the security gateway GW to the caller terminal DTE that is preferably a mobile phone (31).

The example described in FIG. 3 assumes that the caller identity was already identified and validated before and that the original call connection failed. Therefore, after sending the encrypted challenge to the caller, the service provider server SPS sets the validated identification data into a hold state.

The mobile phone DTE and/or the subscriber identity module SIM or alike incorporated therein decrypt(s) the encrypted challenge and sets (32) up a new call connection to the service provider SP. The exchange SPS redirects (33) the call to a customer servant SERV and provides the customer servant SERV with the already validated identification information and the challenge sent to the caller. If the caller then gives the right challenge to the customer servant, the caller may be provided with the service in question.

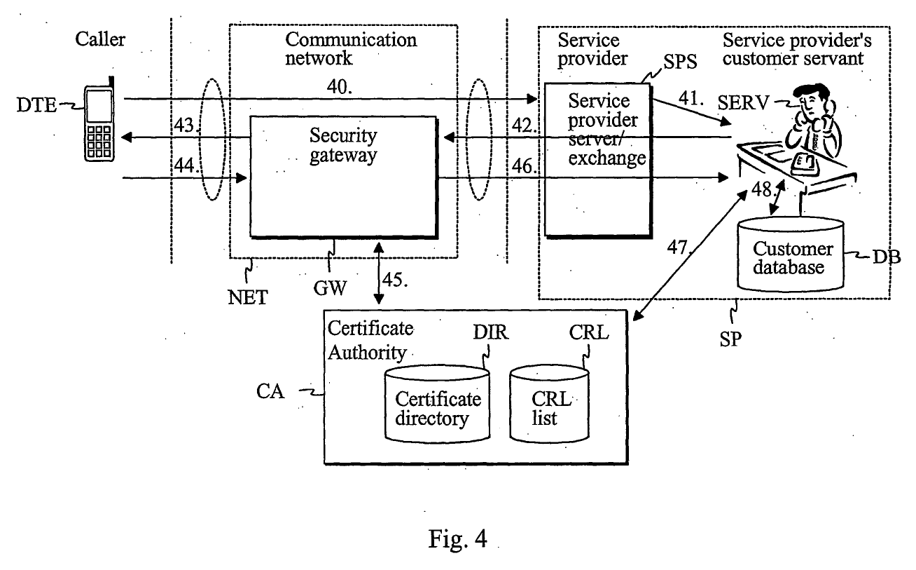

FIG. 4 describes another embodiment of a user verification procedure. A call is set up (40) from a caller terminal DTE to a service number of a service provider SP via a communication network NET. The service provider SP refers e.g. to any private, commercial or state-owned institution, e.g. to a bank, police, post office, operator, credit card company, insurance company, telephone bank or social insurance institution. It may, however, be any other company or institution that provides services requiring undisputed identification of the caller. In FIG. 4, the service provider SP comprises at least a service provider server/exchange SPS, customer database DB and customer servant SERV. The communication network NET is preferably a mobile telephone network. The caller terminal DTE is preferably a mobile phone comprising a subscriber identity module SIM. Instead of a subscriber identity module SIM, a Wireless Identity Module (WIM), an UMTS Subscriber Identity Module (USIM), a security module or any other tamper-proof device can be used. The subscriber identity module SIM or any other tamper-proof device enables encryption and decryption of information and also forming of a digital signature.

The service provider exchange SPS connects (41) the call to a free customer servant SERV. After that the customer servant SERV transmits (42) a caller identification request to the security gateway GW. In FIG. 4, the security gateway GW is owned by the operator of the communication network NET and it provides various security-related functions, such as encrypting and decrypting. The request is transmitted to the security gateway GW through a secured connection (e.g. Secured Sockets Layer (SSL)) e.g. in the form of HyperText Transfer Protocol (HTTP), Wireless Markup Language (WML) or Extensible Markup Language (XML). It is very important to note that the call connection is maintained during the identification phase.

The security gateway GW identifies the service provider SP based on a service provider certificate, decrypts the secured connection and receives the caller identification request in clear text e.g. in the form of XML, WML or short message. The caller identification request is then converted into a form understood by the subscriber identity module SIM of the mobile terminal DTE and encrypted with symmetric encryption method of the Global System for Mobile communications (GSM). The encrypted message is then sent (43) to the mobile phone DTE.

The mobile phone DTE and/or the subscriber identity module SIM decrypt(s) the message and the decrypted message is displayed to the caller on the display of the mobile phone DTE. The subscriber identity module SIM may comprise a browser that converts the message into SIM Toolkit commands prior to displaying the message on the display. The displayed message is then digitally signed with an authentication key of the caller, and the signed message is sent (44) to the security gateway GW. The signed message is preferably converted into the form Public-Key Cryptography Standards #1 (PKCS#1) and encrypted prior to sending. PKCS#1 is further described e.g. in http://www.rsasecurity.com/rsalabs/pkcs/.

The security gateway GW decrypts the message and fetches (45) a certificate related to the subscriber from a certificate directory DIR of a certificate authority CA. The certificate authority CA maintains one or more certificate directories and a certificate revocation list CLR related to revoked or unusable certificates. The certificate authority CA may also comprise information about which users are authorized for one or more services and which are not. The term authorization itself refers to the process of giving someone permission to do or have something. A certificate comprises identification information of the certificate owner and above all, the public key of the owner. With the public key it is possible to verify a digital signature. Furthermore, the security gateway GW creates a PKCS#7 message and sends (46) the message directly to the customer servant SERV preferably using a secured connection. PKCS#7 is further described e.g. in http://www.rsasecurity.com/rsalabs/pkcs/.

The customer servant SERV verifies (47) the digital signature and checks from the certificate revocation list CLR that the certificate is valid. If the verification procedure was successful, the caller may now be provided with the requested service after fetching (48) the caller-related information from a customer database DB.

As described with FIG. 4, the verification procedure and validation of the caller may in another embodiment be in its entirety implemented in the security gateway GW.

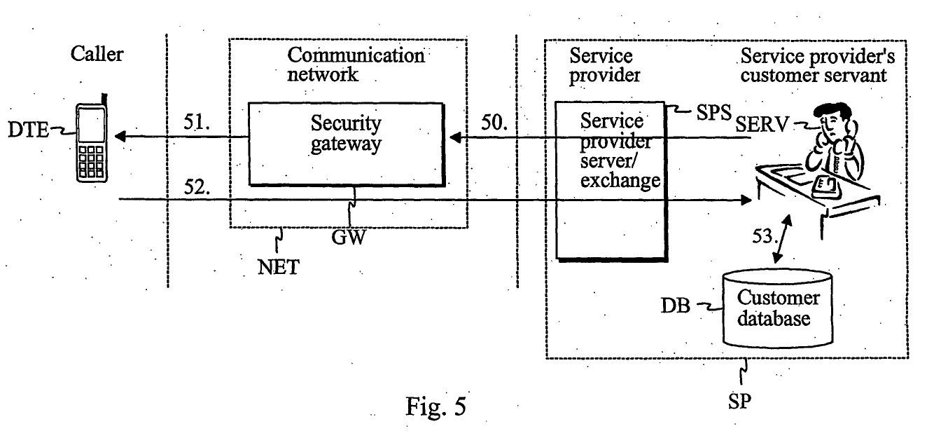

FIG. 5 describes an embodiment in which the originally establish call connection fails and the call connection is re-established.

When the customer servant SERV realizes that the call connection does not exist any more, it creates a challenge. A challenge is any piece of information containing e.g. alphanumeric characters. The challenge is then encrypted using the public key of the caller. The public key is acquired from a previous PKCS#7 message or if such message has not been received from a public certificate directory. After this the encrypted challenge is sent (50) via the security gateway GW to (51) the caller terminal DTE which is preferably a mobile phone.

The example described in FIG. 5 assumes that the caller identity was already identified and validated before and that the original call connection failed after that. Therefore, after sending the encrypted challenge to the caller, the customer servant SERV sets the validated identification data into a hold state.

The mobile phone DTE and/or the subscriber identity module SIM or alike incorporated therein decrypts the encrypted challenge and sets (52) up a new call connection directly to the customer servant SERV. If the caller then gives the right challenge to the customer servant, caller-related information is fetched (53) from a database and the caller may be provided with the service in question.

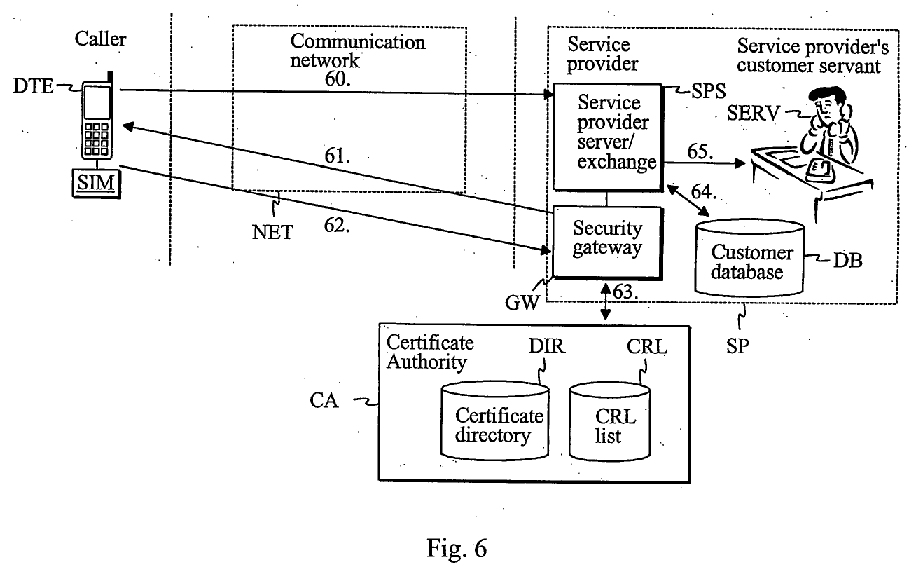

FIG. 6 describes an embodiment of a user identification procedure. In FIG. 6, the security gateway GW is property of the service provider SP.

A call is set up (60) from a caller terminal DTE to a service number of a service provider SP via a communication network NET. The service provider SP refers e.g. to a bank, police, post office, operator, credit card company, insurance company, telephone bank or social insurance institution. It may, however, be any other company or institution that provides services requiring undisputed identification of the caller. In FIG. 6, the service provider SP comprises at least a service provider server/exchange SPS, the security gateway GW, customer database DB and customer servant SERV. The communication network NET is preferably a mobile telephone network. The caller terminal DTE is preferably a mobile phone comprising a subscriber identity module SIM, a Wireless Identity Module (WIM), an UMTS Subscriber Identity Module (USIM), a security module or any other tamper-proof device. The subscriber identity module SIM or any other tamper-proof device enables encryption and decryption of information and also forming of a digital signature.

The caller must, however, be properly identified before providing any services to the caller. Therefore, the security gateway GW in connection with the service provider server SPS sends a caller identification request to the security gateway GW. The security gateway GW provides various security-related functions, such as encrypting and decrypting. The request (61) is transmitted to mobile phone DTE through a secured connection (e.g. Secured Sockets Layer (SSL)) e.g. in the form of HyperText Transfer Protocol (HTTP), Wireless Markup Language (WML) or Extensible Markup Language (XML) or a message of any other form that may be secured or encrypted. The encryption method used can by symmetric or asymmetric.

It is very important to note that the call connection is maintained during the identification phase.

The mobile phone DTE and/or the subscriber identity module SIM decrypt(s) the message and the decrypted message is displayed to the caller on the display of the mobile phone DTE. The subscriber identity module SIM may comprise a browser that converts the message into SIM Toolkit commands prior to displaying the message on the display. The displayed message is then digitally signed with an authentication key of the caller and the signed message is sent (62) back to the security gateway GW. The signed message is preferably converted into the form Public-Key Cryptography Standards #1 (PKCS#1) and encrypted prior to sending.

In another embodiment of FIG. 6, the mobile phone itself creates a PKCS#7 message and sends (62) it to the security gateway GW. The message can additionally be encrypted before sending.

The security gateway GW decrypts the message and fetches (63) a certificate related to the subscriber from a certificate directory DIR of a certificate authority CA. The certificate authority CA maintains one or more certificate directories and a certificate revocation list CLR related to revoked or unusable certificates. The certificate authority CA may also comprise information about which users are authorized for one or more services and which are not. The term authorization itself refers to the process of giving someone permission to do or have something. A certificate comprises identification information of the certificate owner and above all, the public key of the owner. With the public key it is possible to verify a digital signature.

The security gateway GW verifies the digital signature and checks from the certificate revocation list CLR that the certificate is valid. If the verification procedure was successful, the caller may now be provided the requested service. Furthermore, the service provider server SPS may create a data record containing the caller information (64) from a database DB, validation information and a call log information. Call log information simply indicates the call has been established during the identification procedure. The customer servant SERV preferably uses a computer, and therefore, is automatically provided (65) with the aforementioned data record prior to talking to the caller.

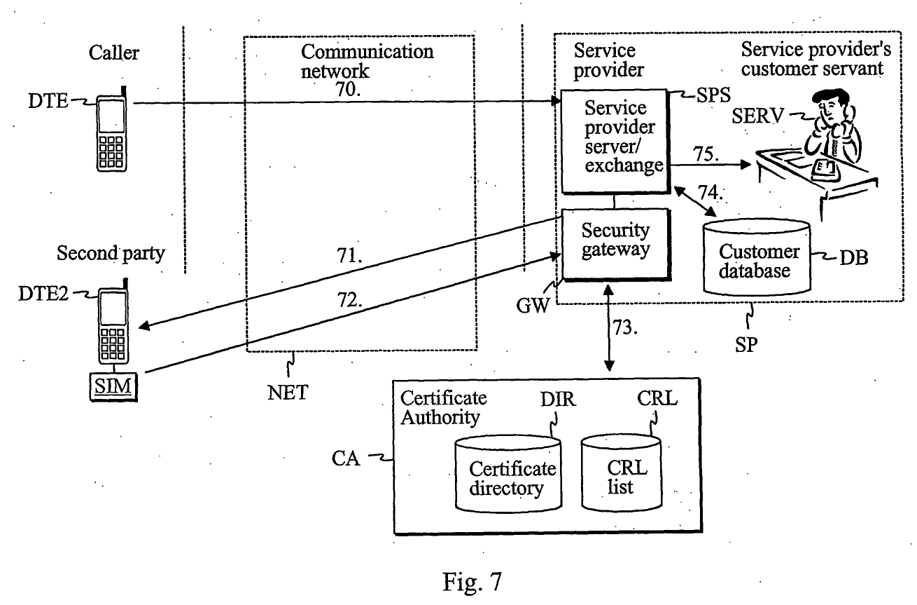

FIG. 7 describes an embodiment of a user identification procedure. In FIG. 7, the security gateway GW is property of the service provider SP. Furthermore, in FIG. 7 the caller is identified by a second party.

A call is set up (70) from a caller terminal DTE to a service number of a service provider SP via a communication network NET. The service provider SP refers e.g. to a bank, police, post office, operator, credit card company, insurance company, telephone bank or social insurance institution. It may, however, be any other company or institution that provides services requiring undisputed identification of the caller. In FIG. 7, the service provider SP comprises at least a service provider server/exchange SPS, the security gateway GW, customer database DB and customer servant SERV. The communication network NET is preferably a mobile telephone network. The caller terminal DTE is preferably an ordinary phone or a mobile phone S comprising a subscriber identity module, a wireless identity module, an UMTS subscriber identity module, a security module or any other tamper-proof device.

The caller must, however, be properly identified before providing any services to the caller. Therefore, the security gateway GW in connection with the service provider server SPS sends a caller identification request to a security gateway GW. The security gateway GW provides various security-related functions, such as encrypting and decrypting. The request (71) is then transmitted to a second terminal DTE2 through a secured connection (e.g. Secured Sockets Layer (SSL)) e.g. in the form of HyperText Transfer Protocol (HTTP), Wireless Markup Language (WML) or Extensible Markup Language (XML) or a message of any other form that may be secured or encrypted. The encryption method used can by symmetric or asymmetric. The second terminal DTE2 is preferably a mobile phone comprising a subscriber identity module, a wireless identity module, an UMTS subscriber identity module, a security module or any other tamper-proof device. However, the second terminal DTE2 may refer to any other terminal, e.g., a computer or Personal Data Assistant (PDA), that can be used in identifying the identity of the caller. The second terminal must therefore comprise means for encrypting and/or signing messages.

The second mobile phone DTE2 and/or the subscriber identity module SIM decrypt(s) the message, and the decrypted message is displayed to the user on the display of the second mobile phone DTE2. The subscriber identity module SIM may comprise a browser that converts the message into SIM Toolkit commands prior to displaying the message on the display. The displayed message is then digitally signed with an authentication key of the user and the signed message is sent (72) back to the security gateway GW. The signed message is preferably converted into the form Public-Key Cryptography Standards #1 (PKCS#1) and encrypted prior to sending.

In another embodiment of FIG. 7, the mobile phone itself creates a PKCS#7 message and sends (72) it to the security gateway GW. The message can additionally be encrypted before sending.

The security gateway GW decrypts the message and fetches (73) a certificate related to the user of the second mobile phone DTE2 from a certificate directory DIR of a certificate authority CA. The certificate authority CA maintains one or more certificate directories and a certificate revocation list CLR related to revoked or unusable certificates. The certificate authority CA may also comprise information about which users are authorized for one or more services and which are not. The term authorization itself refers to the process of giving someone permission to do or have something. A certificate comprises identification information of the certificate owner and above all, the public key of the owner. With the public key it is possible to verify a digital signature.

The security gateway GW verifies the digital signature and checks from the certificate revocation list CLR that the certificate is valid. If the verification procedure was successful, the caller may now be provided the requested service. Furthermore, the service provider server SPS may create a data record containing the caller information (74) from a database DB, validation information and a call log information. Call log information simply indicates the call has been established during the identification procedure. The customer servant SERV preferably uses a computer, and therefore, is automatically provided (75) with the aforementioned data record prior to talking to the caller.

As described in FIG. 7, the caller is verified by another person via the logical channel. In a preferred embodiment, the first logical channel exists while the identifying the identity of the user of the first terminal via the second logical channel. Therefore is possible that the actual caller can be practically anybody but the identification must be acquired from a predetermined party.

In another embodiment of FIG. 7, the first logical channel between the first terminal and the service provider does not exist while identifying procedure of the identity of the user of the first terminal DTE is made via the second logical channel. In one embodiment, the user of the first terminal DTE sends a service request (70) to the service provider SP. The service request is e.g. a bank transaction request. The request will not be accepted until an authorization is received from a second terminal DTE2. For acquiring the authorization, the service provider SP sends a user identification request of the user of the first terminal DTE to the second terminal DTE2 (71). The user identification is the digitally signed by the second terminal DTE and/or the subscriber identity module and the signed message is sent back to the service provider (72). If the verification process (73, 74) of the digital signature is positive, the service request placed by the user of the first terminal DTE can be accepted (75).

In this embodiment, the first terminal DTE refers e.g. to an ordinary telephone, a mobile phone, a computer or a Personal Data Assistant (PDA). Therefore, the aforementioned service request may be made via a phone call, email, short message service or any other messaging system. The second terminal DTE2 is preferably a mobile phone comprising a subscriber identity module, a wireless identity module, an UMTS subscriber identity module, a security module or any other tamper-proof device. However, the second terminal DTE2 may refer to any other terminal, e.g. a computer or Personal Data Assistant (PDA), that can be used in identifying the identity of the caller. The second terminal DTE2 must therefore comprise means for encrypting and/or signing messages.

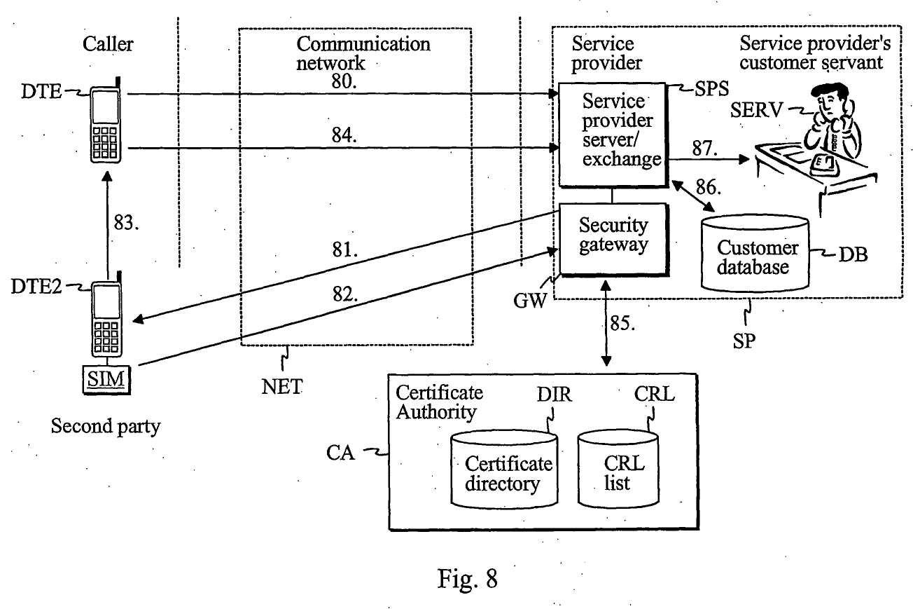

FIG. 8 describes an embodiment of a user identification procedure. In FIG. 8, the security gateway GW is property of the service provider SP. Furthermore, in FIG. 8 the caller is identified by a second party.

A call is set up (80) or a message is sent from a user terminal DTE to a service provider SP via a communication network NET. A service request is made via the call or message. In this embodiment, the first logical channel between the user terminal DTE and the service provider SP may not exist while identifying procedure of the identity of the user of the first terminal DTE is made via the second logical channel. The service provider SP refers e.g. to a bank, police, post office, operator, credit card company, insurance company, telephone bank or social insurance institution. It may, however, be any other company or institution that provides services requiring undisputed identification of the caller. In FIG. 8, the service provider SP comprises at least a service provider server/exchange SPS, the security gateway GW, customer database DB and customer servant SERV. The communication network NET is preferably a mobile telephone network. The user terminal DTE is e.g. an ordinary telephone, or more preferably a mobile phone comprising a subscriber identity module, a wireless identity module, an UMTS subscriber identity module, a security module or any other tamper-proof device.

The user must, however, be properly identified before providing any services to the user. Therefore, the security gateway GW in connection with the service provider server SPS sends a user identification request to a security gateway GW. The request comprises also a challenge. A challenge is any piece of information containing e.g. alphanumeric characters. The security gateway GW provides various security-related functions, such as encrypting and decrypting. The request (81) is then transmitted to a second terminal DTE2 through a secured connection (e.g. Secured Sockets Layer (SSL)) e.g. in the form of HyperText Transfer Protocol (HTTP), Wireless Markup Language (WML) or Extensible Markup Language (XML) or a message of any other form that may be secured or encrypted. The second terminal DTE2 is preferably a mobile phone comprising a subscriber identity module, a wireless identity module, an UMTS subscriber identity module, a security module or any other tamper-proof device. The encryption method used can by symmetric or asymmetric.

The second mobile phone DTE2 and/or the subscriber identity module SIM decrypt(s) the message comprising also the challenge, and the decrypted message is displayed to the user on the display of the second mobile phone DTE2. The subscriber identity module SIM may comprise a browser that converts the message into SIM Toolkit commands prior to displaying the message on the display. The displayed message comprising the challenge is then digitally signed with an authentication key of the user and the signed message is sent (82) back to the security gateway GW. The signed message is preferably converted into the form Public-Key Cryptography Standards #1 (PKCS#1) and encrypted prior to sending.

In another embodiment of FIG. 8, the second mobile phone itself DTE2 creates a PKCS#7 message and sends (82) it to the security gateway GW. The message can additionally be encrypted before sending.

After signing and sending the signed message to the service provider SP, the user of the second mobile phone DTE2 provides the challenge to the user of the first terminal DTE (83). The user of the first terminal DTE is provided with the challenge e.g. via a phone call, short message service, email etc. If the original connection (80) does not exist any more, the user of the first terminal DTE sets up another call (84) or sends another message to the service provider SP via the communication network NET. The user must provide the service provider with the challenge acquired from the user of the second mobile phone DTE2.

The security gateway GW decrypts the message and fetches (85) a certificate related to the user of the second mobile phone DTE2 from a certificate directory DIR of a certificate authority CA. The certificate authority CA maintains one or more certificate directories and a certificate revocation list CLR related to revoked or unusable certificates. The certificate authority CA may also comprise information about which users are authorized for one or more services and which are not. The term authorization itself refers to the process of giving someone permission to do or have something. A certificate comprises identification information of the certificate owner and above all, the public key of the owner. With the public key it is possible to verify a digital signature.

The security gateway GW verifies the digital signature and checks from the certificate revocation list CLR that the certificate is valid. If the verification procedure was successful, the caller may now be provided the requested service. Furthermore, the service provider server SPS may create a data record containing the user information (86) from a database DB and validation information. The customer servant SERV preferably uses a computer, and therefore, is automatically provided (87) with the aforementioned data record prior to talking to the caller.

In this embodiment, the first terminal refers e.g. to an ordinary telephone, a mobile phone, a computer or a Personal Data Assistant (PDA). Therefore, the aforementioned service request may be made via a phone call, email, short message service or any other messaging system. The second terminal DTE2 is preferably a mobile phone comprising a subscriber identity module, a wireless identity module, an UMTS subscriber identity module, a security module or any other tamper-proof device. However, the second terminal DTE2 may refer to any other terminal, e.g. a computer or Personal Data Assistant (PDA), that can be used in identifying the identity of the user of the first terminal DTE. The second terminal DTE2 must therefore comprise means for encrypting and/or signing messages.

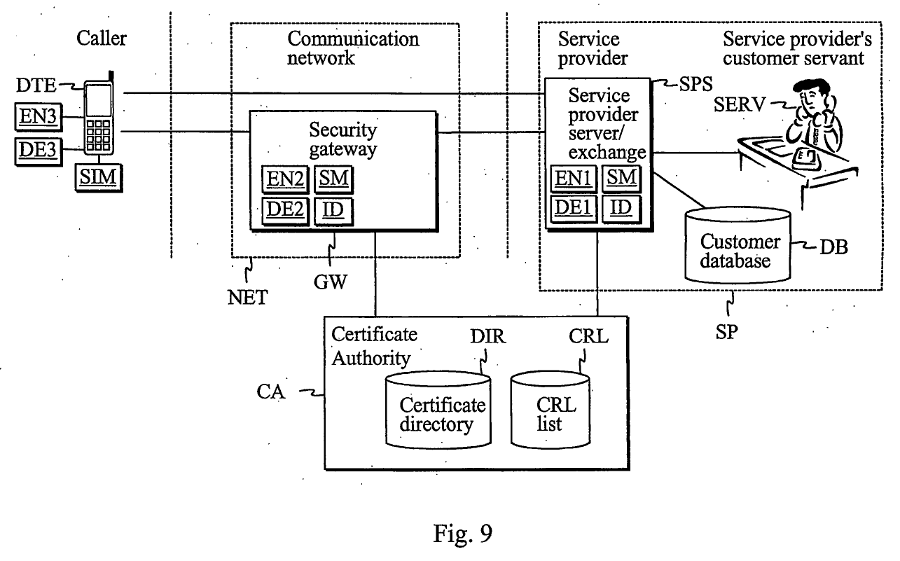

FIG. 9 describes an example of a preferred system in accordance with the present invention. The system comprises a communication network NET, a caller terminal DTE associated with the communication network NET and a service provider SP associated with the communication network NET. The caller terminal DTE is preferably a mobile phone and the communication network NET a GSM network, a GSM network with a GPRS feature or an UMTS network.

The system further comprises a service provider server/exchange SPS and a customer servant SERV. The customer servant SERV provides a caller with a service. Furthermore, the system comprises a security gateway GW that is used to provide various security functions in the system, e.g. encrypting and decrypting. The system comprises also a certificate authority CA that has access both to a certificate directory and certificate revocation list CLR.

Sending means SM for sending a caller identification request are arranged in the service provider server/exchange SPS. The service provider server/exchange SPS furthermore comprises first encrypting means EN1 for encrypting information, first decrypting means DE1 for decrypting information and identifying means ID for identifying the caller after a call has been set up prior to providing any services to the caller based on the information provided by the certificate authority CA. The aforementioned sending means SM are arranged also to send a challenge to the caller terminal DTE in the event that the telephone connection set up between the caller terminal DTE and service provider SP fails. In one embodiment, the aforementioned sending means SM are arranged also to send a challenge to the second terminal DTE2.

The security gateway GW comprises sending means SM for sending a caller identification request, identifying means ID for identifying the caller after a call has been set up prior to providing any services to the caller based on the information provided by the certificate authority CA, second encrypting means EN2 for encrypting information and second decrypting means DE2 for decrypting information.

The caller terminal DTE comprises a subscriber identity module SIM, third encrypting means EN3 for encrypting information and third decrypting means DE3 for decrypting information. Instead of a subscriber identity module SIM, a Wireless Identity Module (WIM), an UMTS Subscriber Identity Module (USIM), a security module or any other tamper-proof device can be used. The subscriber identity module SIM or any other tamper-proof device enables encryption and decryption of information and also forming of a digital signature.

The aforementioned means are implemented e.g. by software and/or hardware in a way known to skilled in art and therefore they are not described in more detail.

FIGS. 1-9 disclose different configurations of the system in accordance with the present invention. In FIGS. 1-9, the certificate authority acts as a certificate service provider. It must be noted that any other appropriate party can as well act as a certificate service provider. It is also possible, however not depicted in the figures, that the security gateway is managed by the service provider and that the certificate service provider functions are provided by the service provider itself. Furthermore, it is possible that the service provider acts also as a certificate service provider, and therefore, a distinct trusted third party is not needed. Although it is described in FIGS. 1-9 that the terminal devices DTE, DTE2 are mobile phones, they can be any other appropriate terminal devices. Moreover, although it has been described that the mobile phone and/or security gateway use(s) PKCS#1 or PKCS#7 messages in validation messaging, PKCS#1 and PKCS#7 messages are used only as examples and any other appropriate messages can be used.

The present invention describes a solution wherein a logical channel (e.g. a call connection) is set up between a caller terminal and a service provider. The problem is how to reliably verify the identity of the caller. Therefore, in accordance with the present invention the caller is authenticated via a another preferably secured logical channel between the service provider and the caller terminal prior to providing any services to the caller via the established call connection. The transmission channel itself is known to a man skilled in the art and refers e.g. to a connectionless packet data connection via a mobile communication network or a packet connection using the secure and standardized GSM feature described e.g. in the ETSI TS 101 181 V8.8.0 (2001-12) publication. However, the transmission channel may also refer to a circuit switched connection.

Furthermore, the present invention provides a secure solution for identification, authentication, validation and authorization of a user via two logical channels.

It is obvious to a person skilled in the art that with the advancement of technology, the basic idea of the invention may be implemented in various ways. The invention and its embodiments are thus not limited to the examples described above, instead they may vary within the scope of the claims.

1. A method for authenticating a user of a first terminal in a communication system, wherein the method comprises:
setting up a first logical channel via a communication network between a first terminal and a service provider; and
identifying the identity of the user of the first terminal after the first logical channel set up via a second logical channel other than the established first logical channel between the service provider and the first terminal prior to providing any services to the user of the first terminal.

2. The method according to claim 1, wherein the method further comprises:
sending a user identification request from the service provider to the first terminal via the second logical channel while the first logical channel exists between the first terminal and the service provider;
receiving the user identification request with the first terminal while the first logical channel exists;
digitally signing the request;
sending the signed request with the first terminal via the second logical channel;
authenticating the user of the first terminal and verifying the digital signature; and
providing the user with services provided by the service provider via the first logical channel.

3. The method according to claim 1, wherein the method further comprises:
sending a user identification request for the user of the first terminal from the service provider to a second terminal via the second logical channel while the first logical channel exists between the first terminal and the service provider;
receiving the user identification request with the second terminal while the first logical channel exists;
digitally signing the request;
sending the signed request with the second terminal via the second logical channel;
authenticating the user of the second terminal and verifying the digital signature; and
providing the user of the first terminal with services provided by the service provider via the first logical channel.

4. The method according to claim 1, wherein the method further comprises:
sending a user identification request for the user of the first terminal from the service provider to a second terminal via the second logical channel, the user identification request comprising also a challenge;
receiving the user identification request comprising the challenge with the second terminal;
digitally signing the request comprising the challenge;
sending the signed request with the second terminal via the second logical channel;
providing the user of the first terminal with the challenge with the second terminal;
providing the service provider with the challenge acquired from the user of the second terminal;
comparing the challenge in the signed message from the second terminal and the challenge provided by the user of the first terminal; and if the challenges are equal,
authenticating the user of the second terminal and verifying the digital signature; and
providing the user of the first terminal with services provided by the service provider via the first logical channel.

5. The method according to claim 1, wherein the first and/or second logical channel refers to a packet switched connection.

6. The method according to claim 1, wherein the first and/or second logical channel refers to a circuit switched connection.

7. The method according to claim 1, wherein the method further comprises:
arranging a security gateway forming an interface towards the first and/or second terminal.

8. The method according to claim 7, wherein the method further comprises:
identifying the service provider with the security gateway;
sending a user identification request from the service provider to the security gateway;
sending the user identification request from the security gateway to the first terminal via the second logical channel;
receiving the identification request with the first terminal;
digitally signing the request;
sending the signed request to the security gateway via the second logical channel;
retrieving a certificate related to the user of the first terminal;
authenticating the identify of the user of the first terminal and verifying the digital signature; and
providing the user of the first terminal a service provided by the service provider via the existing first logical channel.

9. The method according to claim 7, wherein the method further comprises:
identifying the service provider with the security gateway;
sending a user identification request of the user of the first terminal from the service provider to the security gateway;
sending the user identification request from the security gateway to a second terminal via the second logical channel;
receiving the user identification request with the second terminal;
digitally signing the request;
sending the signed request of the security gateway via the second logical channel;
retrieving a certificate related to the user of the second terminal;
authenticating the identify of the user of the second terminal and verifying the digital signature; and
providing the user of the first terminal a service provided by the service provider via the existing first logical channel.

10. The method according to claim 2, wherein the method further comprises:
encrypting the user identification request sent to the first and/or second terminal using symmetric or asymmetric encryption; and
encrypting the signed request sent from the first and/or second terminal using symmetric or asymmetric encryption.

11. The method according to claim 8, wherein the method further comprises:
encrypting the signed user identification request sent to the security gateway using symmetric or asymmetric encryption.

12. The method according to claim 8, wherein the method further comprises:
retrieving with the security gateway a certificate related to the user of the first and/or second terminal;
creating and sending a validating message to the service provider; and
validating the user of the first and/or second terminal with the service provider based on the validating message and validating information.

13. The method according to claim 8, wherein the method further comprises:
retrieving with the security gateway validation information comprising at least a certificate related to the user of the first and/or second terminal;
authenticating the identify of the user of the first and/or second terminal with the security gateway abased on the validation information; and
sending a positive validation message to the service provider if the result of the validation was positive.

14. The method according to claim 1, wherein if the first logical channel fails during the validation procedure, the method further comprises:
creating a challenge;
encrypting the challenge with the public encryption key of the user of the first terminal;
sending the encrypted challenge to the fist terminal;
decrypting the encrypted challenge in the first terminal;
setting up a new logical channel to the service provider;
providing the service provider with the decrypted challenge; and if the challenge is acceptable,
providing the user of the first terminal via the logical channel with a service provided by the service provider.

15. The method according to claim 14, wherein the method further comprises:
sending the encrypted challenge to the first terminal via a security gateway.

16. A system for authenticating a user of a first terminal in a communication system, the system comprising:
a communication network (NET),
a first terminal (DTE) associated with the communication network (NET),
a service provider (SP) associated with the communication network (NET),
a service provider (SP) associated with the communication network (NET),
a certificate service provider (CA),
sending means (SM) for sending a user identification request to the first terminal (DTE) or a second terminal (DTE2); and
identifying means (ID) for identifying the identity of the user of the first terminal (DTE) after a first logical channel has been set up via a second logical channel other than the established first logical channel between the service provider and the first terminal (DTE) prior to providing any services to the user of the first terminal (DTE) based on the information provided by the certificate service provider (CA).

17. The system according to claim 16, wherein the system further comprises:
a security gateway (GW) in connection with the service provider (SP) and certificate service provider (CA).

18. The system according to claim 17, wherein the security gateway (GW) is managed by the service provider (SP).

19. The system according to claim 17, wherein the security gateway (GW) is managed by a third party.

20. The system according to claim 16, wherein said sending means (SM) are arranged in the service provider (SP).

21. The system according to claim 16, wherein said sending means (SM) are arranged in the service provider (SP) and security gateway (GW).

22. The system according to claim 16, wherein said identifying means (ID) are arranged in the service provider (SP) and/or security gateway (GW).

23. The system according to claim 16, wherein the service provider (SP) comprises:
first encrypting means (EN1) for encrypting information; and
first decrypting means (DE1) for decrypting information.

24. The system according to claim 17, wherein the security gateway (GW) comprises:
second encrypting means (EN2) for encrypting information; and
second decrypting means (DE2) for decrypting information.

25. The system according to claim 16, wherein the first terminal (DTE) and/or second terminal (DTE2) comprises:
third encrypting means (EN3) for encrypting information; and
third decrypting means (DE3) for decrypting information.

26. The system according to claim 20, wherein said sending means (SM) are arranged to send a challenge to the first terminal (DTE) in the event that the logical channel set up between the first terminal (DTE) and service provider (SP) fails.

27. The system according to claim 20, wherein said sending means (SM) are arranged to send a challenge to the second terminal (DTE2).

28. The system according to claim 16, wherein the communication network is a GSM network.

29. The system according to claim 16, wherein the communication network is a GSM network with the GPRS feature.

30. The system according to claim 16, wherein the communication network is an UMTS, a CDMA, a WCDMA, an EDGE, a Bluetooth, or a WLAN network.

31. A system for authenticating a user of a first terminal in a communication system, the system comprising:
a communication network (NET),
a first terminal (DTE) associated with the communication network (NET),
a service provider (SP) associated with the communication network (NET),
a service provider (SP) associated with the communication network (NET),
a certificate service provider (CA),
a sender (SM) for sending a user identification request to the first terminal (DTE) or a second terminal (DTE2); and
an identifier (ID) for identifying the identity of the user of the first terminal (DTE) after a first logical channel has been set up via a second logical channel other than the established first logical channel between the service provider and the first terminal (DTE) prior to providing any services to the user of the first terminal (DTE) based on the information provided by the certificate service provider (CA).
